(19) United States
(12) Patent Application Publication
(10) Pub. No.: US 2003/0233261 A1
(43) Pub. Date: Dec. 18, 2003

(54) Automobile insurance system, automobile insurance center and automobile

(76) Inventors: Hirofumi Kawahara, Osaka (JP); Noriko Kawahara, Osaka (JP); Minori Kawahara, Osaka (JP); Megumi Kawahara, Osaka (JP); Kazuki Kawabata, Osaka (JP)

Correspondence Address: DITTHAVONG & CARLSON, P.C., Suite A, 10507 Braddock Road, Fairfax, VA, 22032, US

(21) Appl. No.: 10/430,012

(22) Filed: May 7, 2003

(30) Foreign Application Priority Data
Oct. 19, 2000 (JP) 2000-319179

(51) Int. Cl. G06F 17/60

(52) U.S. Cl. 705/4

(57) ABSTRACT

A video camera for photographing a running state of an automobile is provided in the automobile and the photographed video is recorded in a recording device. When a sensor mounted on the automobile detects occurrence of an accident by detecting an impact or the like, data containing the running state recorded by the recording device is transmitted to an insurance center which computes insurance payment for the accident through a transmission system. As a result, there can be provided an automobile insurance system so that a driver comes to be conscious of safe driving.

### BACKGROUND OF THE INVENTION

1.. Field of the Invention

The present invention relates to an automobile insurance system, an automobile insurance center and an automobile, and more particularly, it relates to an automobile insurance system, an automobile insurance center, and an automobile which can reduce the number of traffic accidents.

2.. Description of the Background Art

A driving state recording system using a monitoring camera of particular interest to the present invention is disclosed in Japanese Patent Laying-Open Gazette No. 11-298853, for example. This discloses that a driving state of an automobile is recorded by a monitoring camera for photographing inside and outside of the automobile and the recorded video information is used for ascertaining the cause of the accident.

Furthermore, Japanese Patent Laying-Open Gazette No. 2000-113060 discloses an insurance payment agreement operating system for providing automobile damage insurance payment for an accident car. This discloses the insurance payment agreement operating system in which when video data, vehicle type specific data, damage point data, degree of damage data are input, estimated data for a repairing cost is generated and agreement data is transmitted to a computer of an insurance company.

The conventional driving state monitoring and insurance payment system regarding an automobile have been organized as described above.

The prior art in the above documents only discloses that the data referring to assessment and payment for repairing costs of the accidental vehicle is exchanged between a repair shop and an insurance company. In other words, a damage point is photographed by a video camera in a repair plant after the accident and the video is only used for showing accuracy of repair assessment and cost reduction required for negotiation with an insurance company.

### SUMMARY OF THE INVENTION

It is an object of the present invention to provide an automobile insurance system by which an accident situation can be objectively acquired and a driver comes to be concerned with safe driving.

The present invention comprises an automobile insurance system which computes insurance payment of an automobile insurance using data collected by a driver monitoring system mounted on an automobile. The driver monitoring system comprises a video camera for photographing a driving state of a driver, and the collected data comprises the driving state of the driver photographed by the video camera.

Since the insurance amount is computed based on the data obtained by photographing the driving state of the driver, the situation in the event of the accident can be objectively obtained.

In addition, since the driver's driving state is always monitored, he/she comes to be conscious of safe driving.

Preferably, the driver monitoring system comprises an emergency notification system and the video camera comprises a recording device for recording an image before the time the emergency notification system detected occurrence of an accident. Since the video camera has recorded the video before and after the occurrence of the accident, the state before and after the accident can be acquired.

Further preferably, the driver monitoring system informs an insurance center which handles insurance transaction for an automobile accident of the occurrence of an accident and driving state before and after the accident recorded by the recording device when the emergency notification system detected the occurrence of the accident.

When the occurrence of the accident was detected, the insurance center which handles the insurance transaction for the automobile accident is informed of the fact of the occurrence of the accident and the driving state before and after the accident, the insurance center can take prompt transaction by acquiring necessary data at the same time the accident occurred.

According to another aspect of the present invention, an automobile insurance system comprises a system for monitoring a driving state of a driver using a video camera provided in an automobile, an emergency notification system provided in the automobile and notifying an emergency situation, and a device for transmitting monitored data such as the video photographed by the video camera comprised in the monitoring system to an insurance center which handles insuring transaction when the emergency notification system was operated.

According to still another aspect of the present invention, an automobile insurance center receives data from an emergency accident notification system provided in an automobile and computes an insurance amount of an accident. The emergency notification system comprises a video camera for monitoring a driving state of a driver, and the insurance center figures out a state when the accident was occurred using video information photographed by the video camera at the time of the accident to compute the insurance payment.

Since the insurance center figures out the state when the accident was occurred using video information photographed by the video camera for monitoring the driving state of the driver at the time of the accident to compute the insurance payment, it can compute the insurance payment for the accident by objectively acquiring the accidental situation.

The accident notification system may further comprise a sensor for detecting the occurrence of the accident.

According to still another aspect of the present invention, an automobile insurance system comprises an automobile insurance system in which an automobile insurance company uses data collected by a driver monitoring system mounted on an automobile. The driver monitoring system comprises a video camera for photographing a driving state of a driver, the collected data comprises the driving state of the driver photographed by the video camera, and the insurance company changes an insurance fee depending on whether the driver monitoring system is provided in the automobile or not.

Since the insurance company changes the insurance fee depending on whether the driver monitoring system is provided in the automobile or not, a driver comes to provide the video camera in the automobile to reduced the insurance fee. As a result, the driver comes to be conscious of safe driving and in case the accident occurred, since many drivers come to provide the video camera, the insurance transaction can be promptly carried out.

According to further another aspect of the present invention, an automobile comprises a video camera for photographing the front of the automobile, a sensor for detecting emergency such as the occurrence of an accident, and a device for transmitting data just before the occurrence of the emergency photographed by the video camera to an insurance center which handles insurance transaction for an automobile accident when the sensor detected the occurrence of the emergency.

Since the video camera for monitoring the driving state of the driver is provided in the automobile and the data photographed by the video camera is transmitted to the insurance center which handles the insurance transaction for the automobile accident when the accident occurred, there can be provided the automobile which facilitates prompt transaction for the accident.

### BRIEF DESCRIPTION OF THE DRAWINGS

FIG. 1 is a block diagram showing an essential part of an insurance system using a video camera equipped in an automobile;

FIG. 2 illustrates information which is necessary to clarify an accident fact and an accident situation and to compute a damage amount;

FIG. 3 is a block diagram showing an essential part of an emergency notification system provided in an automobile;

FIG. 4 illustrates an operation panel;

FIG. 5 is a block diagram showing an essential part of an insurance center.

FIG. 6 is a flowchart showing processing procedures in an insurance processing center;

FIG. 7 is a flowchart showing processing procedures in the insurance processing center;

FIG. 8 illustrates a display of an accident site;

FIG. 9 illustrates a track and a speed change of an accidental automobile;

FIG. 10 is a flowchart showing processing procedures of video processing;

FIG. 11 illustrates contents of the video processing;

FIG. 12 illustrates procedures for calculating a distance between a camera and an object from a size of the object on a screen;

FIG. 13 illustrates an accident situation;

FIG. 14 illustrates determining procedures of a comparative fault ratio;

FIG. 15 illustrates a structure of a fault determination database;

FIG. 16 illustrates a fault ratio assessment screen;

FIG. 17 illustrates an example of a display screen of traffic violation points;

FIG. 18 illustrates an effect of the insurance system using the video camera installed in an automobile; and

FIG. 19 illustrates a case where the insurance system using the video camera is applied to a motorcycle.

### DESCRIPTION OF THE PREFERRED EMBODIMENT

Hereinafter, an embodiment of the present invention will be described with reference to the accompanying drawings. FIG. 1 is a view showing an automobile insurance system according to an embodiment of the present invention. Referring to FIG. 1, in the embodiment of the automobile insurance system (which is sometimes referred to as a car video insurance system in the following description) to which the present invention is applied, an automobile 5 which is driven by an automobile insurant to be described later is equipped with a driver monitoring system for monitoring a driving state (video in the driving direction). Meanwhile, there is an insurance center 30 which handles the transaction of accident based on the automobile insurance system, and the automobile 5 and the insurance center 30 can be communicated with each other through a network 100. The network 100 may be a public network, a closed network, a wireless network or a network through satellite.

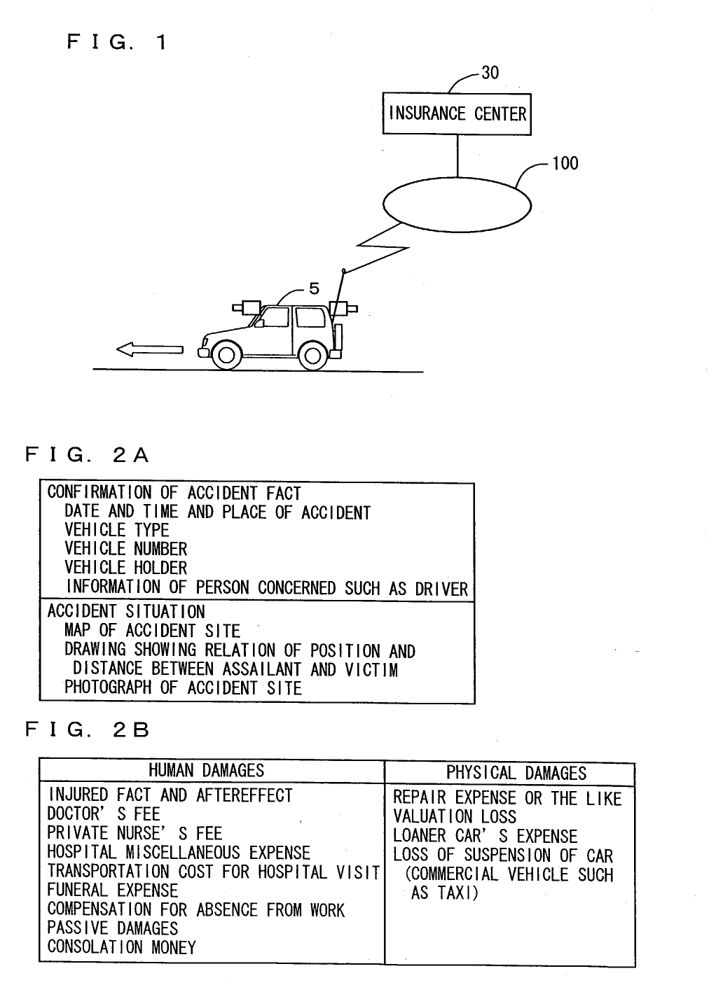

FIGS. 2A and 2B illustrate information which is necessary to clarify an accident fact and an accident situation necessary for handling of the accident and data which is necessary for computation of a damage amount in an automobile insurance. FIG. 2A illustrates the data necessary to figure out the accident fact and the accident situation. To confirm the accident fact, the following data is necessary, that is, the date and time and place of the accident, a vehicle type, a vehicle number, a vehicle holder, information of the person concerned such as a driver.

Meanwhile, in order to confirm the accident situation, the following data is necessary, that is, a map of an accident site, a drawing showing the relation of position and distance between an assailant and a victim and a photograph of the accident site.

FIG. 2(B) illustrates the data necessary for computation of the damage amount, in which there are human damages and physical damages.

In order to compute the human damages, the following data is necessary, that is, an injured fact and an aftereffect, a doctor's fee, a private nurse's fee, a hospital miscellaneous expense, transportation costs for hospital visits, a funeral expense, compensation for absence from work, passive damages, and consolation money. Furthermore, in order to compute the physical damages, the following data is necessary, that is, a repair expense or the like, a valuation loss, a loaner car's expense, a loss of suspension of a car (in case of a commercial vehicle such as a taxi).

The automobile insurance system according to the present invention comprises these data and may automatically collect other information if necessary.

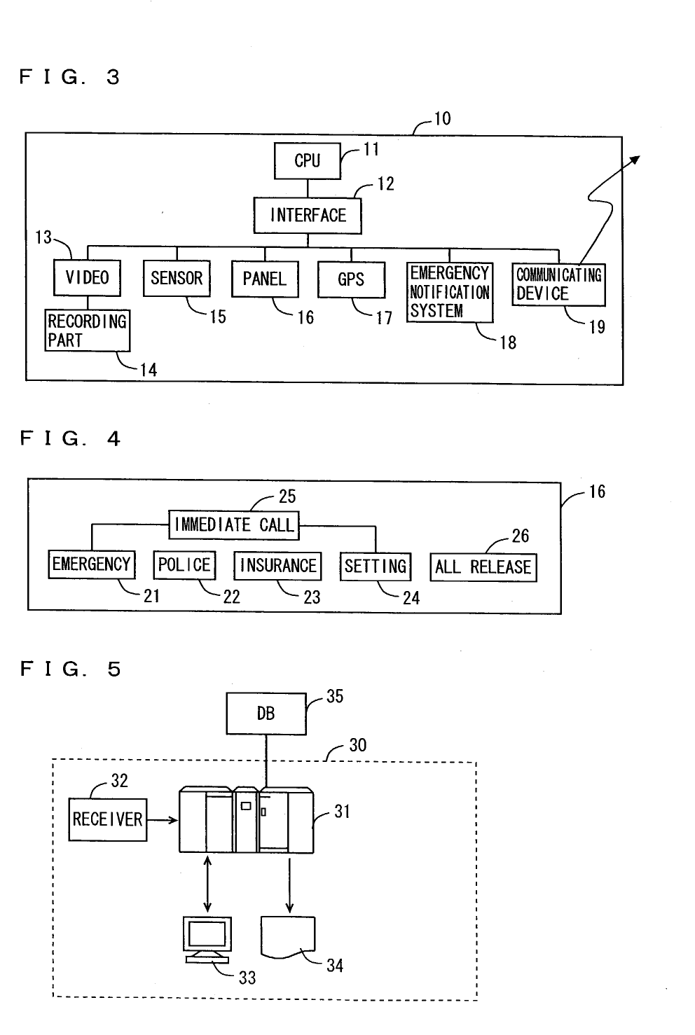

FIG. 3 is a block diagram showing an essential part of a driver monitoring system 10 provided in the automobile 5 shown in FIG. 1. Referring to FIG. 3, the driver monitoring system 10 comprises a CPU 11 for controlling the whole of the driver monitoring system 10, a video camera 13 connected to the CPU 11 through an interface 12 and having a recording device 14 or the like such as a tape for recording, a sensor 15 for detecting occurrence of an accident or the like, an operation panel 16 used for operating the drive monitoring system 10 by a driver, a GPS receiving apparatus 17 for knowing a present position of the automobile 5, an emergency notification system 18 initiated by the censor 15, and a communicating device 19 such as a modem for communicating with the insurance center 30.

As schematically shown in FIG. 1, at least one video camera 13 is provided in the automobile 5 in the running direction.

In addition, the video camera 13 may be provided not only in the running direction but also on the backside or in the lateral direction. Furthermore, the recording apparatus 14 is not limited to a videotape and may be another storage device such as a disc or semiconductor memory so long as only video data is recorded. The recording apparatus may be the one wherein the video image is repeatedly recorded.

In addition, the video camera photographs video using infrared light if necessary so as to clearly obtain the video even when usual shooting is difficult because it is dark or gas is filled.

Further, when the video camera is installed in the car, the position of the camera is set considering the location of the wiper, in the case of rain.

The video camera 13 may be provided in the automobile or outside the automobile. The recording device 14 may be integrated with the video camera 13 or may be provided apart from a shooting part and connected thereto wirelessly or by a fixed line. In this case, only the shooting part may be provided outside.

The sensor 15 is provided to initiate the emergency notification system 18 provided in the automobile 5. In other words, the censor 15 is automatically operated with an impact above a certain level (impact sensor), vibration (vibration censor), pattern recognition of an accident sound (sound censor) or the like. In addition, it may be operated simultaneously with an airbag. Furthermore, as will be described later, it may be manually operated by pressing an emergency notification button or the like which is provided in the operation panel 16. When the emergency notification system 18 is operated, an announcement is automatically made, for example, “The emergency notification system was operated. If an accident occurred, please conduct yourself calmly with human life highest priority. This will call the emergency, the police and the insurance center 30 after twenty seconds. If each button in the operation panel is pressed, the call thereto will be stopped. If you want to call them immediately, please press the call button immediately.”

Meanwhile, the recording device 14 is preferably housed in a hard box which can withstand an impact, fire, water or the like so that driving state data can be obtained by collecting the recording device 14 even when the video camera 13, the communicating device 19 or the like is broken.

Furthermore, in a case an accident occurred at a place where communication is impossible such as in a tunnel, the recording device 14 may be configured to be able to be collected or such that data can be transmitted to an outer device from the recording device 14 through a connector or the like at the accident site.

FIG. 4 illustrates the operation panel 16. Referring to FIG. 4, in the operation panel 16, there are provided an “emergency” button 21, a “police” button 22, an “insurance” button 23, a “setting” button 24, an “immediate call” button 25 and an “all release” button 26. If the “immediate call” button 25 is pressed, the emergency, the police and the insurance center 30 are automatically notified. In addition, a range to be immediately called is set by the “setting” button 24. When the “all release” button is pressed, the call is released.

In addition, a place to be called such as home or a work place can be set by a user using the “setting” button 24.

When the automatic call or manual call is started, the following data is transmitted to aforementioned each place through a communicating device 19 via satellite or the like. The contents of the data to be transmitted may have been previously set. In addition, time when the emergency notification system 18 was operated is regarded as a point of time an accident occurred.

(1) Date and time of the accident

(2) Positional information of the accident

(3) Attribute information of the vehicle (a vehicle number, a vehicle type or the like)

(4) Attribute information of a vehicle holder

(5) Insurance relevant information (an insurance company, a contract number or the like)

(6) Recorded information of a driving state for at least a few seconds before the accident (it is assumed that each information is synchronized with time information)

It is assumed that the above each of information (3) through (5) has been previously input from the operation panel 16 and stored in a memory (not shown).

(7) A driving state

(i) Video and sound taken at a plurality angles

The video and sound may be compressed by a compression technique such as MPEG or the like.

(ii) Speed

(iii) Braking and handling operation

(iv) Cause of functioning of the system and data of each of sensor

(8) Driver information

This is the information to specify a driver, which is detected by the following methods.

(i) A driver's license is shown to the video camera. Identification is performed by the photograph and the video.

(ii) A driver's license number in the driver's license is read by a device having a function of OCR (optical character reader) attached to the panel 16 (not shown).

(iii) A bar-code is printed (a printed seal is applied) onto the driver's license and read by a bar-code reader attached to the panel 16 (not shown).

(iv) Other than the OCR and the bar-code, magnetic recording and an IC card may be used.

In addition, an original ID card may be used instead of the driver's license. Furthermore, identification technique such as fingerprint or iris may be employed.

It is assumed that the information which can identify the driver by driver's license number or the like is obtained by either of the above methods. The data is input through the panel 16.

Each organization such as the police referrers the data to previously prepared database and the accident state can be displayed on a display. An infrastructure of the car video insurance system can fulfill a great role for the accident situation of the relevant organization.

Furthermore, all of the information may be transmitted as encrypted digital data.

Still further, it is assumed that each of the above information (3) through (5) has been previously stored in the emergency notification system when the driver joined the car video insurance.

Furthermore, The driver monitoring system 10 does not necessarily comprises all of the components shown in FIG. 3 and the operation panel 16, the GPS 17, the emergency notification system 18, the communicating device 19 and the like may be selected and provided if necessary.

Then, description will be made of processing at the insurance center 30. FIG. 5 is a block diagram showing a main structure of the insurance center 30. Referring to FIG. 5, the insurance center 30 comprises a management computer 31 for managing the whole of the insurance center 30, a receiver 32 for receiving information from the emergency notification system, a terminal 33 having a display screen operated by an individual operator, and an output device 34 such as a printer for outputting an amount of insurance or the like to be paid, which was computed by the management computer 31. The management computer 31 comprises a database 35 which stores a contract number, contractual coverage or the like of the insurant information in the automobile insurance system according to the embodiment of the present invention.

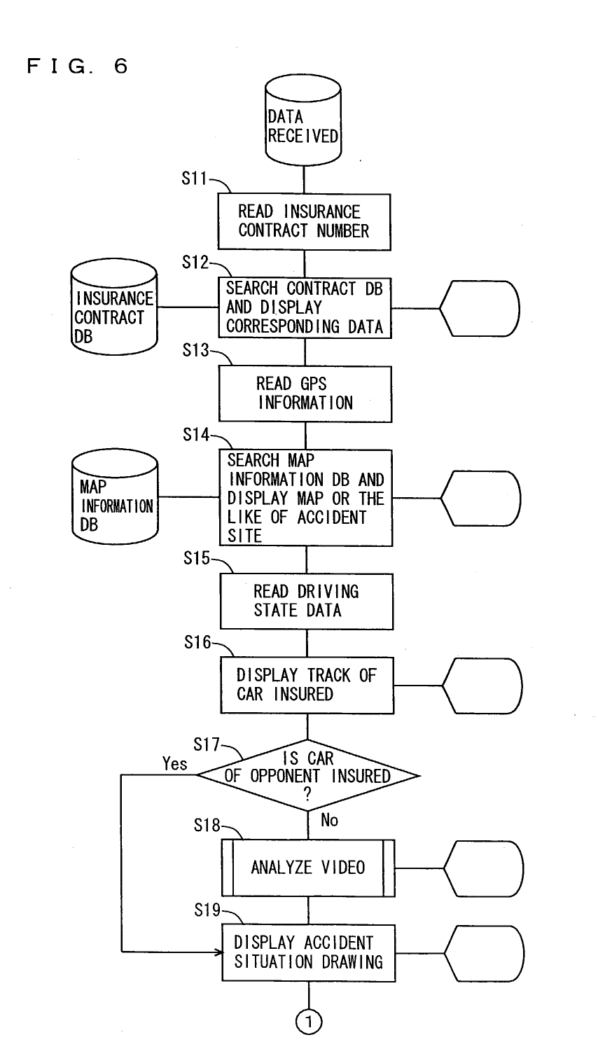

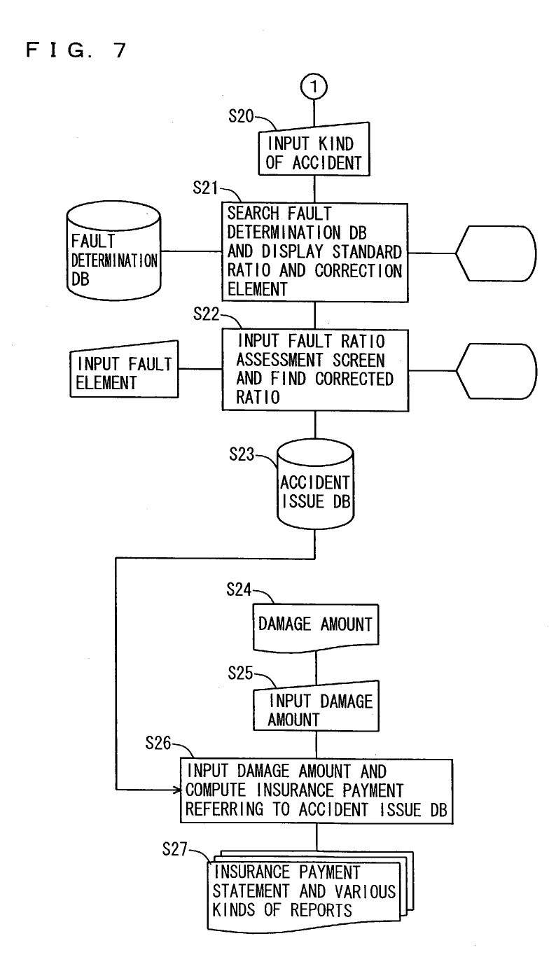

FIGS. 6 and 7 are flowcharts showing processing procedures of the management computer 31 in the insurance center 30. Referring to FIGS. 6 and 7, when data was received from the emergency notification system 18, an insurance contract number is read at step S11. Then, referring to the contract database, appropriate data is searched and displayed at step S12. Then, positional information of the accident is read at step S13 (GPS information may be read). Map information database is searched and a map or the like at the accident site is displayed at step S14. Then, the driving situation data is read at step S15 and the track of the insurant is displayed at step S16. Then, it is determined whether the automobile of the opponent of the accident is an insured car or not at step S17, if it is not (NO at step S17), video data is read, displayed in the screen and analyzed at step S18. Then, the accident situation is displayed based on the analyzed result at step S19.

If the car of the opponent of the accident is an insured car (YES at step S17), the operation is moved to the step S19 and then, the accident situation is displayed.

Then, referring to FIG. 7, the kind of the accident is input at step S20. Fault determination database is searched and a standard ratio and correction elements are displayed at step S21. The data is input to the fault ratio assessment screen to find the corrected ratio at step S22. Thus obtained data is registered in an accident issue database at step S23. Additionally, an amount of damages of the human damages and physical damages are obtained at step S24 and the amount of the damages is input at step S25. An amount of insurance is computed by referring the amount of the damages to the accident issue database based on the data in which fault ratio assessment was performed at step S26. The result is output as insurance payment statement and various kinds of reports at step S27.

In addition, all of the above procedures are not necessarily automatically processed.

Hereinafter, concrete processing of the above each step will be described.

First of all, the insurance center 30 figures out the insurant and the contractual coverage by referring to the insurance coverage database 35 based on the transmitted insurance contractual number. Then, the accident fact is confirmed. This was described in FIG. 2 and the confirmation items have been almost filled in from the information of the emergency notification system as described above.

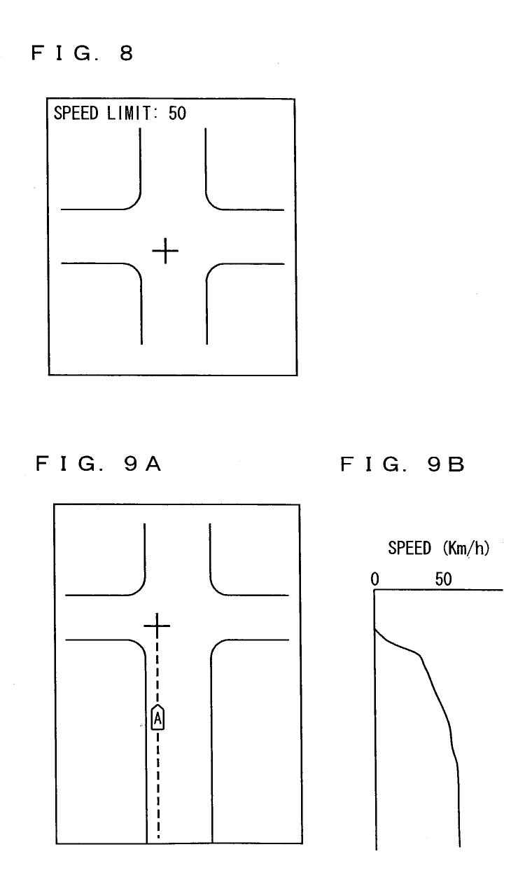

Then, the accident situation is confirmed. The map of the accident site is obtained from the transmitted GPS information and the map information database. FIG. 8 shows such a map of the accident site. The insurance center 30 searches the map information database based on longitude and latitude information (GPS information) of the accident site obtained by the car navigation system and displays the map in the display of the terminal 33.

In the map information database, information such as a width of road, presence or absence of a traffic light, a traffic sign at the accident site, whether the site is a residential area or a shopping area or the like is stored and they can be displayed in the screen if necessary.

The GPS information of an original point (for example, upper left corner in FIG. 8) in a display range of the map at the accident site can be obtained by the map information system and since the coordinate at the accident site is transmitted, an accident point is plotted by “+” in FIG. 8.

The track of the automobile for ten seconds obtained by the driving state record (information such as speed, handling operation or the like) before the accident is automatically shown in the display and the movement of the automobile can be displayed by animation.

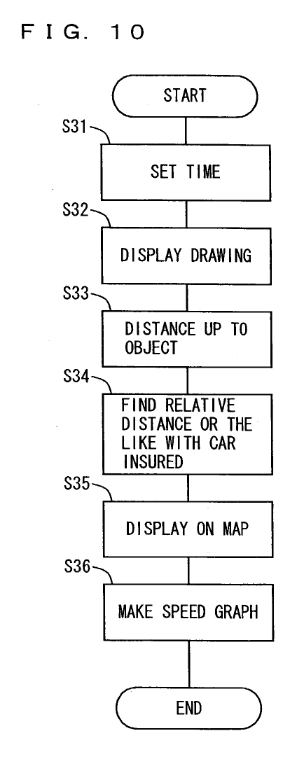

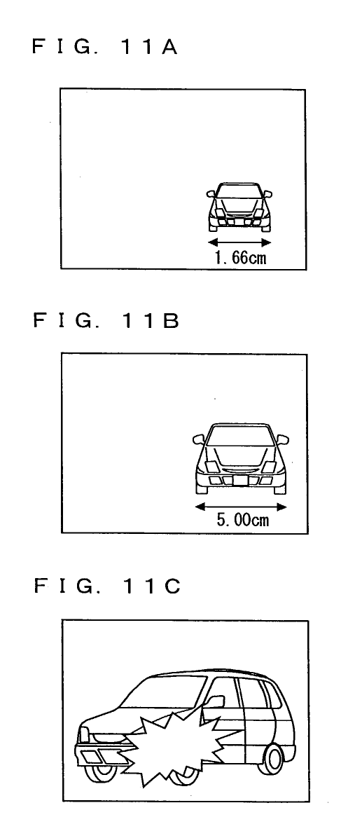

This state is shown in FIGS. 9A and 9B. FIG. 9A shows the track of an accident automobile 10 on the map and FIG. 9B illustrates a change in speed based on received data.

At this time, if the speed limit at this area is known, a section driven over the speed limit may be displayed by red color or the like.

It is assumed that the displayed information shown in FIGS. 8 and 9 is automatically made by receiving the information from the emergency notification system and starting the operation.

If the automobile of the opponent which had the accident with the automobile 5 is also joined to the car video insurance system, the track, speed graph or the like of the automobile of the opponent can be similarly plotted from transmitted data for that automobile.

When running data of the automobile of the opponent is not acquired, if the opponent is a bicycle, a pedestrian or the like, the opponent's movement is confirmed by analysis of the video.

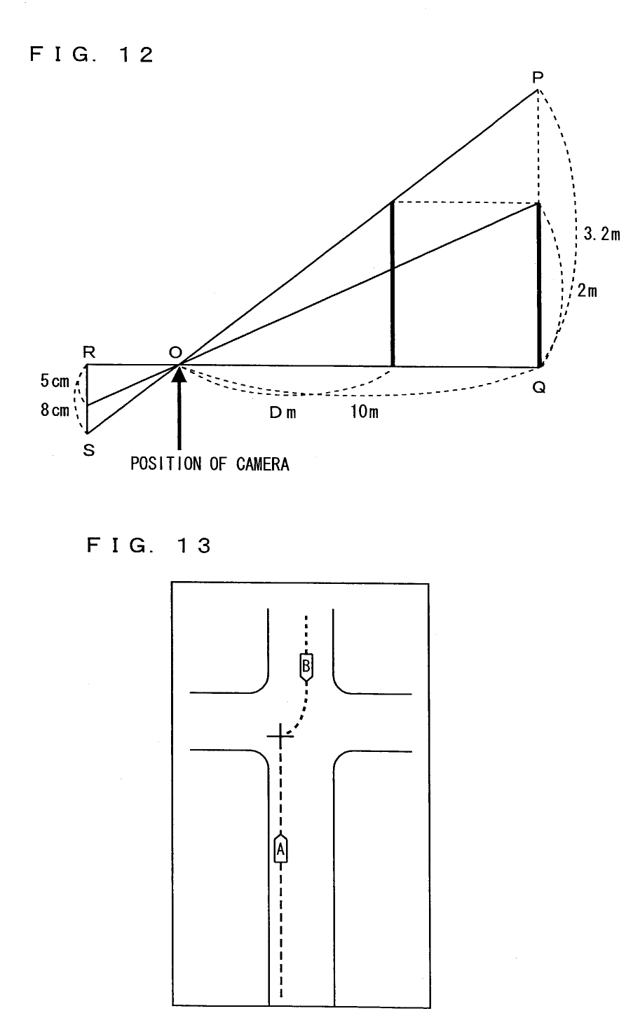

Then, analyzing procedures of the video will be described. FIG. 10 is a flowchart showing analyzing procedures of the video which is the video analyzing processing shown at step S18 shown in FIG. 6. FIG. 11 illustrates a displayed examples of concrete screens. Referring to FIGS. 10 and 11, it is assumed that an object which is 2 meters wide and 10 meters away from the camera is represented by 5 centimeters in the display screen in the video of this car video insurance system.

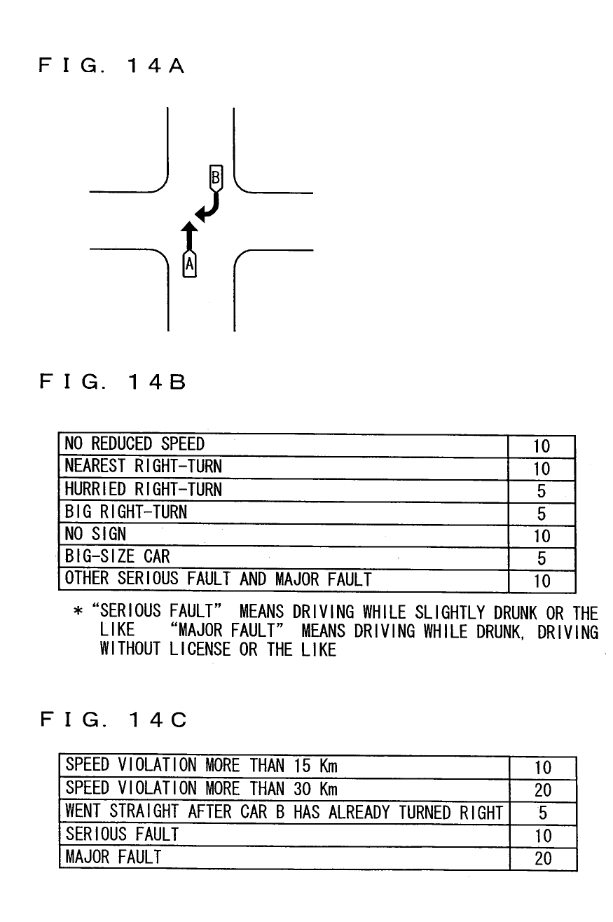

Hereinafter, this respect will be described with reference to FIG. 12. FIG. 12 illustrates a relation between a position (O) of the video camera, a position (Q) of an object and a position (R) of the object in the screen. Referring to FIG. 12, procedures for finding a distance D(m) when the same object of 2 meters is 8 centimeters in the screen will be described.

If the length of segment PQ is x, it follows that x=2×8/5=3.2. Since 10:x=D:2, it follows that D=20/x. If x is represented by length c in the screen, it follows that x=2×c/5. Then, if this is substituted for the previous equation, it follows that D=20×5/2×c=50/c.

As described above, in the case of the aforementioned video camera, the distance D (m) up to the object is found by 50/c. Here, c (cm) is the length in the screen, which can be measured by appropriately stopping the video.

Referring to FIGS. 11A and 11B again, FIG. 11A shows the video which was four seconds before the accident and it is found that a relative distance is 30 meters. FIG. 11B shows the video which was two seconds before the accident and it is found that the relative distance is 10 meters. Since the relative moving distance for two seconds is 20 meters, it is found that an average relative speed is 36 km/h.

FIG. 11C shows the video when the accident occurred. The relative distance is 0 meter and the relative moving distance for two seconds is 10 meters, so that it is found that the average relative speed is 18 km/h.

The distance shown by an arrow in the figure can be measured by a method of dragging it in the screen.

For example, if the width of an automobile B is found from its vehicle type and the vehicle width in the screen is measured, a relative distance from a automobile A can be calculated.

If two screens are measured at certain time intervals, since a relative moving distance (M:unit is m) and elapsed time (T;unit is second) can be found, the average relative speed S=(360/T*M)/1000 (km/h) during the elapsed time can be easily calculated.

As a matter of convenience, although the time interval was two seconds in FIG. 11, it is needless to say that any time interval may be employed. Furthermore, since the data such as the video is synchronized with the time information and the time information is well-known, the video can be stopped any time to operate this operation.

In addition, if it is assumed that a camera angle is fixed at the center of the screen, a lateral position can be automatically acquired by calculating a distance between the center of the arrow used in measuring the vehicle width and the center of the screen in the lateral direction. Furthermore, in order to minimize an error, this operation can be performed by magnifying the screen at appropriate magnifications. The track of the automobile B can be drawn in FIG. 9A by repeating above operations.

Thus, the tracks are displayed as in FIG. 13.

Furthermore, an operator at the terminal 33 may manually plot the movement of the automobile B on the screen shown in FIG. 13 while seeing the video on the screen and this screen may be manually corrected also.

If only the length such as the vehicle width is given as a reference, even when the opponent is a motorcycle, a bicycle, a pedestrian or the like, the operation can be performed by the same procedures. At this time, the kind of the opponent (a vehicle, a pedestrian or the like) is input.

Furthermore, in a case there are a plurality of opponents, the same procedures are repeated for respective opponents.

Still further, in the actual system, workability and precision can be improved if image processing technique and measurement technique are applied. For example, when the object is represented by three-dimensional wire frame and simulated so as to be synchronized with the video, or pattern recognition technique for the video is applied, it is possible to reduce or simplify the aforementioned procedures such as dragging of the arrow line.

Thus, the drawing and animation representing the accident situation can be made by computer-processing the transmitted various data and video record which represents the accident situation, which contributes to objective and speedy processing for the accident.

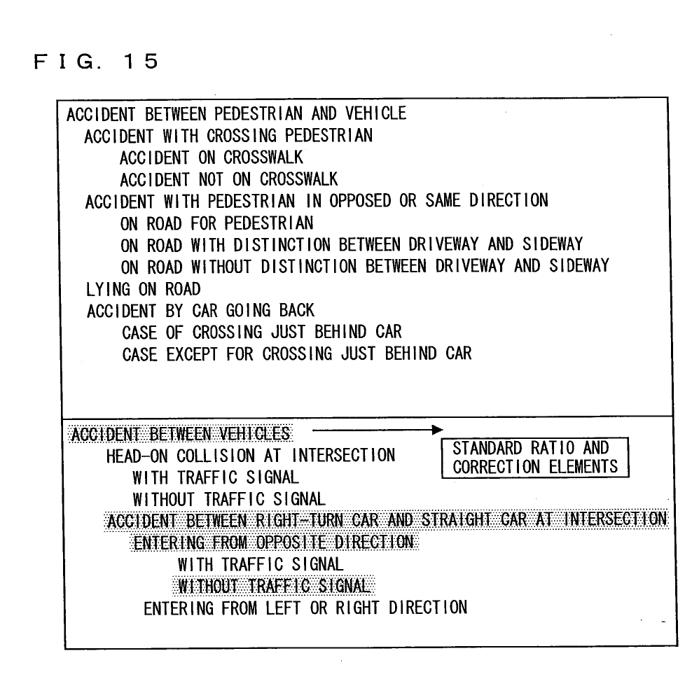

Then, certification of comparative fault ratio will be described. FIGS. 14A through 14C are drawings for describing the certification of the comparative fault ratio. As shown in FIG. 14A, for example, it is assumed that a straight car A and a right-turn car B had an accident at the intersection without a traffic light. When the car A went straight and the car B turned right from the opposite direction, the comparative fault ratio is certified in the following elements.

(i) A standard fault ratio of the car A and the car B is 20:80. This is defined by a priority standard for a car going straight.

(ii) If the car B had the following element, the fault ratio of the car A can be reduced by a certain value. For example, if the car B was a big-size car and there was no sign, the fault ratio is 5:95.

FIG. 14B is a list showing comparative fault ratio for the opponent's car and FIG. 14C is a list showing comparative fault ratio for the car concerned.

If the car A had an element shown in FIG. 14C, the fault ratio of the car A is added by a certain value.

Furthermore, certification of the comparative fault ratio is determined by forming a past determination database based on certification standard of comparative fault ratio made by a court or the like and past examples and comparing and referring it to the current accident situation.

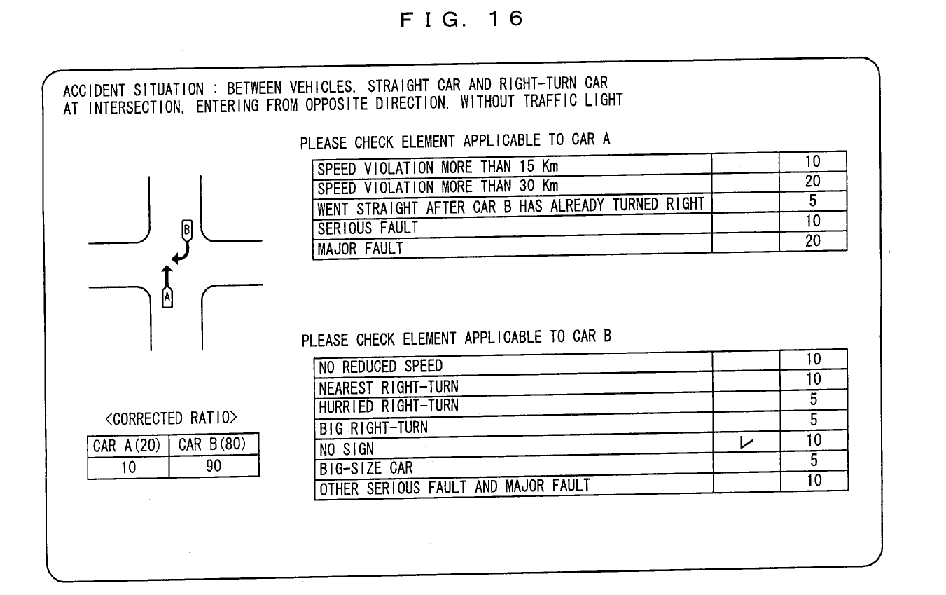

The fault determination database is systemized according to the kind of the accident as shown in FIG. 15.

It is known that the current accident is the kind of accident shown by half-tone dot meshing in FIG. 15. An instruction such as “this is an accident between a right-turn car and a straight car at an intersection without a traffic light and the right-turn car entered from the opposite direction” is made by keywords or in table form. Then, a list of a standard ratio and correction elements is extracted from the fault determination database.

As a result, a fault ratio assessment screen is displayed as shown in FIG. 16.

The operator inputs check marks on corresponding items in the list referring to the video and the screen shown in FIG. 16. As shown in FIG. 16, the comparative fault ratio in which the correction elements were added is displayed at the lower left in the screen.

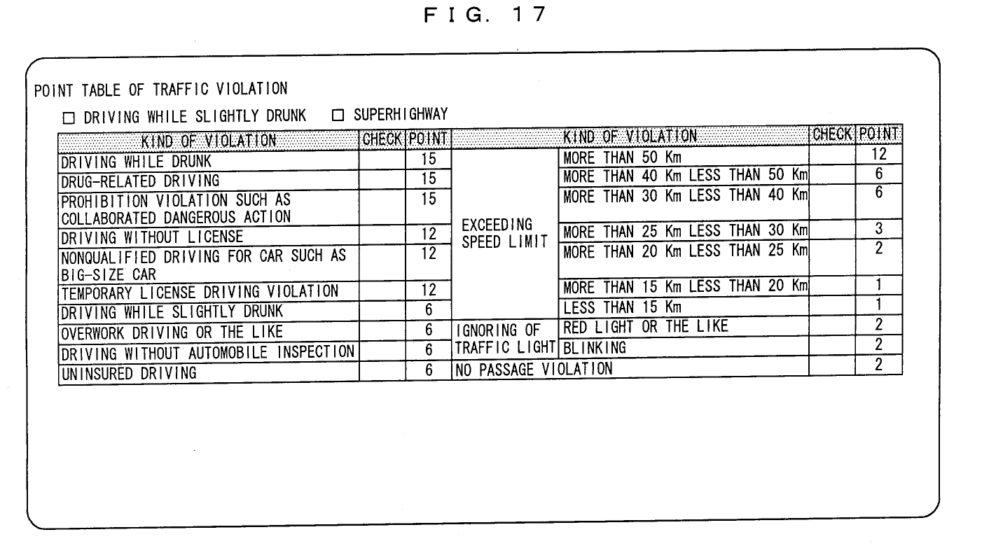

In order to determine a serious fault, a major fault or the like, a point table referring to traffic violations as shown in FIG. 17 may be input into the list and automatically reflected to the assessment.

In addition, in this fault ratio assessment screen, it may be automatically determined whether there is a correction element or not based on the information acquired in the process of making the drawing of the accident situation in FIG. 13.

More specifically, actions such as “went straight after the car B has already turned right”, “no reduced speed”, “nearest right-turn” and the like are to be previously defined. For example, if “no reduced speed” is defined as it is not more than 10 km/h, when the speed at the time of right-turn is more than 10 km/h, it can be determined to be “right-turn with no reduced speed”. Thus, the fault ratio assessment can be automatically determined including whether there is a speed violation or not at the stage of the animation display.

At this time, a probability corresponding to the correction element may be obtained using fuzzy inference. For example, it is defined as follows.

If “a distance between two cars is not more than about 3 meters” and “the car B changed from the straight to the right in the running direction at an angle of 30 degrees or more”, then “it corresponds to the nearest right-turn”.

Thus, in a case the distance was 3.5 meters or the turn angle was 28 degrees or the like, the case is represented by the probability that it may be determined to be the nearest right-turn. If the same inference is made in the case of the speed violation, objectivity and impartiality of the comparative fault ratio determination can be improved.

Thus, labor in confirming the fact of the accident situation or the like is considerably saved by using automatically recorded data of the car video insurance system.

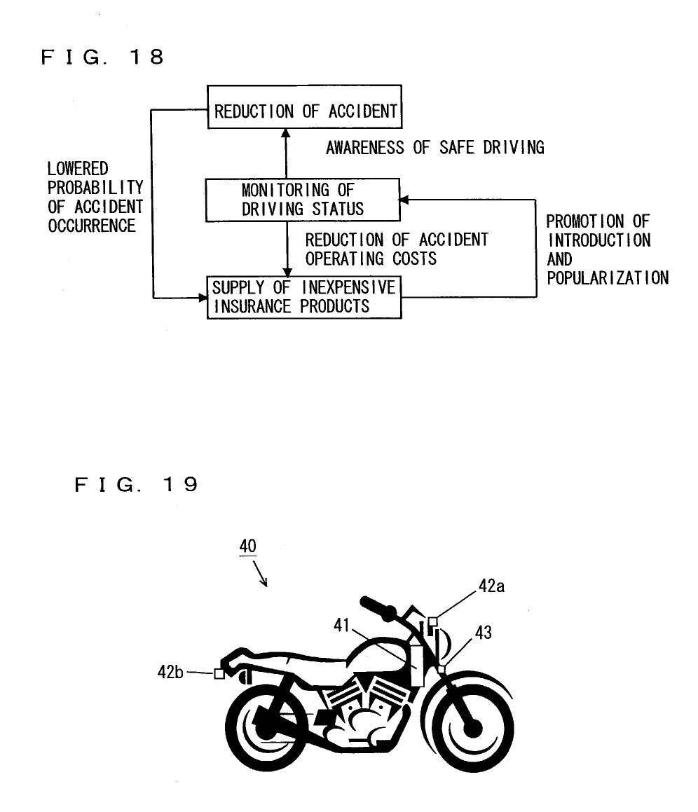

FIG. 18 is a diagram for describing an effect obtained by using the automobile insurance system according to the present invention. Referring to FIG. 18, a driver comes to be conscious of safe driving because the driving state is monitored. As a result, the probability of accident occurrence is lowered and the insurance expense is reduced. Furthermore, since costs for handling accidents can be reduced, inexpensive insurance products can be supplied. Consequently, introduction and popularization of the automobile insurance system is promoted, whereby the safety awareness of driving can be raised.

In addition, although the automobile insurance system was described when it is applied to the four-wheeled vehicle in the above embodiment, it is not limited to this and may be applied to general means of land transportation such as an electric train, a motorcycle, a bicycle or the like and means of water transportation including a small craft such as a wet bike or the like.

FIG. 19 illustrates a motorcycle to which the automobile insurance system is applied. Referring to FIG. 19, a motorcycle 40 is provided with video cameras (can be a CCD camera) 42a and 42b provided at front and rear sides, a sensor 43 at a suspension part of a front wheel and a controller 41 including a CPU or recording device at a front. The controller 41 includes components of the automobile insurance system 10 shown in FIG. 3 except for the video camera and the sensor.

Furthermore, the positions of the video camera, the sensor and the like are not limited to the positions shown in FIG. 19 and they may be any positions so long as necessary information can be acquired.

Still further, although the example using the video camera was described in the above embodiment of the present invention, a digital camera which can photograph continuous images may be used.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An automobile insurance system of computing an amount of payment of an automobile insurance using data collected by a driver monitoring system mounted on an automobile, wherein said driver monitoring system comprises a video camera for photographing a driving state of a driver, and said data collected comprises the driving state of the driver photographed by said video camera.

2. An automobile insurance system according to claim 1, wherein said driver monitoring system comprises an emergency notification system and said video camera comprises a recording device for recording an image before the time said emergency notification system detects occurrence of an accident.

3. An automobile insurance system according to claim 2, wherein said recording device is housed in a hard container which withstands an impact and fire.

4. An automobile insurance system according to claim 2, wherein said driver monitoring system informs an insurance center which handles insurance transaction for an automobile accident of occurrence of an accident and driving states before the accident which were recorded by said recording device when said emergency notification system detected the occurrence of the accident.

5. An automobile insurance system according to claim 1, wherein the data collected by said driver monitoring system comprises driver specific information.

6. An automobile insurance system comprising:
a system for monitoring a driving state of a driver using a video camera mounted on an automobile;
a sensor mounted on said automobile, for detecting occurrence of an accident; and
a device for informing an insurance center which handles insurance transaction for an automobile accident of monitored data stored in said monitoring system when said sensor detected occurrence of an accident.

7. An automobile insurance center receiving data from an accident notification system provided in an automobile and computing an insurance amount for an accident, wherein said accident notification system comprises a video camera for monitoring a driving state of a driver, and said insurance center figures out a state when the accident was occurred using video information acquired by said video camera at the time of the accident and computes an insurance amount.

8. An automobile insurance center according to claim 7, wherein said accident notification system further comprises a sensor for detecting occurrence of an accident.

9. An automobile insurance system in which an automobile insurance company uses data collected by a driver monitoring system, wherein said driver monitoring system comprises a video camera for photographing a driving state of a driver, said data comprises the driving state of the driver photographed by said video camera, and said insurance company changes an insurance fee depending on whether said driver monitoring system is provided in an automobile or not.

10. An automobile comprising:
a system for monitoring a driving state of a driver using a video camera;
a sensor for detecting occurrence of an accident; and
a device for informing an insurance center which handles insurance transaction for an automobile accident of monitored data stored in said monitoring system when said sensor detected occurrence of the accident.

11. A method of computing an automobile insurance amount for an accident using data from an accident notification system provided in an automobile comprising:
a step of monitoring a driving state of a driver using a video camera;
a step of acquiring a state when an accident occurred using video information photographed by said video camera at the time of the accident; and
a step of computing the insurance amount for the accident based on contents acquired by said acquiring step.

12. A method of computing an automobile insurance amount for an accident according to claim 11, wherein said step for acquiring a state when the accident occurred comprises a step of reading an insurance contract number, a step of searching and displaying corresponding data while referring to a contract database, a step of reading positional information when the accident occurred, a step of reading video data, displaying it on a screen and analyzing the video, and a step of displaying an accident situation drawing based on an analyzed result.

13. A method of computing an automobile insurance amount for an accident according to claim 12, further comprising a step of searching a fault determination database, a step of displaying a standard ratio and correction elements, and a step of inputting a fault ratio assessment screen and finding a corrected ratio.

14. A method of computing an automobile insurance amount for an accident according to claim 13, further comprising a step of acquiring a damage amount of human damages and physical damages, and a step of computing an insurance amount while referring to an accident issue database based on data containing the damage amount and fault ratio assessment.

15. A method of computing an automobile insurance amount for an accident according to claim 12, in which the video photographed by the video camera has a predetermined relation between actual dimension of an object and a dimension thereof on a screen, and said step of analyzing the video comprises a step of analyzing movement of a car of accident based on videos photographed at a plurality of times before the accident and displaying a track of the car of accident on said display screen.
